(19) United States
(12) Patent Application Publication
(10) Pub. No.: US 2024/0258868 A1
(43) Pub. Date: Aug. 1, 2024

(54) COOLING ASSEMBLY AND DRIVE ASSEMBLY HAVING A COOLING ASSEMBLY OF THIS KIND

(71) Applicant: Joma-Polytec GmbH, Bodelshausen (DE)

(72) Inventors: Stefan Heinz, Bodelshausen (DE); Alexander Maute, Hechingen-Stetten (DE)

(73) Assignee: Joma-Polytec GmbH, Bodelshausen (DE)

(21) Appl. No.: 18/560,733

(22) PCT Filed: Sep. 16, 2022
(86) PCT No.: PCT/EP2022/075833

§ 371 Date: Nov. 14, 2023

(30) Foreign Application Priority Data
Sep. 17, 2021 (DE) 10 2021 124 101.4

(51) Int. Cl. H02K 5/20; H02K 5/18

(52) U.S. Cl. CPC H02K 5/20; H02K 5/18; H02K 2205/00

(57) ABSTRACT

A cooling assembly for a drive assembly, which comprises an electrical machine, for a vehicle, for cooling the electrical machine, the cooling assembly comprising a cooling channel, with an inlet and an outlet, for conducting a cooling medium, the cooling channel having a receiving region for receiving the electrical machine, the cooling assembly comprising an insert having at least one insertion part for generating turbulence in the cooling medium, the insert being arranged in a space surrounding the receiving region for the electrical machine within the cooling channel, and the insertion part having a two-part design.

The invention relates to a cooling assembly for a drive assembly—in particular in the form of a traction drive—which comprises an electrical machine, for a vehicle, in particular a motor vehicle, for cooling the electrical machine according to the preamble of claim 1, and a drive assembly, in particular a traction drive, for a vehicle, in particular a motor vehicle, with features of the coordinate claim.

During operation of an electrical machine (electric motor), heat is generated in particular at current-conducting parts of the electrical machine. This heat can negatively influence the operation of the electrical machine and is therefore undesirable. In order to enable the most efficient and long-lasting operation of an electrical machine, it is advantageous to cool an electrical machine.

Various solutions for cooling an electrical machine are known from the prior art. For example, cooling passages for conducting a cooling medium can be provided in a cast motor housing. Here, the cooling passages are arranged as close as possible to a stator of the electrical machine.

Furthermore, annular notches can be provided in the motor housing, which notches are closed by means of an outer shell and can thus form a channel for conducting a cooling medium.

In such channels, the cooling medium generally has a laminar flow with which a sufficient cooling effect cannot always be achieved.

It is an object of the present invention to provide a cooling assembly and a drive assembly having such a cooling assembly, wherein an optimal cooling effect can be achieved and ensured by simple means.

This object is achieved by a cooling assembly for a drive assembly, in particular in the form of a traction drive, which comprises an electrical machine, for a vehicle, in particular a motor vehicle, for cooling the electrical machine, with the features of claim 1.

The cooling assembly comprises a cooling channel for conducting a cooling medium. The cooling medium (cooling fluid, coolant) may be a gas and/or a liquid.

The cooling channel has an inlet for introduction of the cooling medium into the cooling channel. The cooling channel also has an outlet for discharging the cooling medium from the cooling channel. The inlet and the outlet are in particular fluidically connected to one another or flow-connected.

The cooling channel has a receiving region for receiving the electrical machine. The electrical machine can be arranged and/or fastened within the receiving region (within the cooling channel). Specifically, in the receiving region, a receiving device can be arranged in the cooling channel, which receiving device is configured to receive, in particular to hold and fasten, the electrical machine.

The cooling medium can flow around the receiving region and in particular the electrical machine arranged in the receiving region of the cooling channel, in particular the outer side of a stator of the electrical machine. The receiving region can surround the electrical machine (in particular radially outwardly). The cooling channel can surround the receiving region or the electrical machine (in particular radially outwardly).

The cooling assembly has an insert with at least one insertion part for generating turbulence (flow vortices) in the cooling medium within the cooling channel. A turbulent flow can be generated from a laminar flow by means of the insertion part.

The insert is arranged (with its insertion part or its insertion parts) within the cooling channel in a space (in particular, an annular space) surrounding the receiving region for the electrical machine (radially outside). In particular, the insert is arranged within the cooling channel in a space (in particular, an annular space) surrounding the electrical machine (radially outside). In other words, the insert can be arranged between the inner wall or the inner circumference of the cooling channel (designed, for example, as a pipe guide) and the outer wall or the outer circumference of the receiving region for the electrical machine or of the electrical machine.

The insertion part of the insert is advantageously designed in two parts.

In the present case, a fluidic connection or flow connection means that a gas and/or a fluid (liquid) can flow between two fluidically coupled elements or between two elements that are in fluidic connection.

In the present case, “axially” or “axial direction” means a direction oriented along the central longitudinal axis of the electrical machine or parallel to the central longitudinal axis of the stator of the electrical machine. In other words, the central longitudinal axis is oriented in the axial direction.

Accordingly, “radially” or “radial direction” means a direction oriented perpendicularly to the central longitudinal axis and originating at the central longitudinal axis.

The two-part insertion part, which is used in particular for flow guidance, is particularly simple to manufacture. By means of the two-part insertion part, the flow-conducting and flow-influencing contour of the insertion part can be individually designed and adapted. This allows the greatest possible design freedom of the insertion part per se or of the insert as a whole.

As already indicated above, the cooling assembly has an insert with at least one insertion part for generating turbulence in the cooling medium within the cooling channel. In the simplest case, the two-part insertion part by itself or as a whole forms the insert (to be inserted into the cooling channel). However, depending on the dimensioning and/or shaping of the cooling channel, two or more two-part insertion parts can be provided, which in their entirety form the insert (to be inserted into the cooling channel). The insertion parts may each be designed identically. It is conceivable that two two-part insertion parts, two insert halves so to speak, in their entirety form the insert. Such an insert can be designed to be hollow-cylindrical (in particular in the form of a hollow circular cylinder).

According to a development, the insert part can comprise a first element. The first element can have multiple depressions and/or elevations for generating flow vortices (contoured or structured surface).

A turbulent flow can be generated by the generated flow vortices which arise in that the cooling medium flowing in the cooling channel passes into the depressions or circumvents the elevations. A turbulent flow can accordingly be generated from a laminar flow by means of the depressions and/or elevations of the first element. A turbulent flow has a significantly better cooling effect than a laminar flow. The first element can be designed in one piece.

The turbulent flow can be adjusted as desired by varying the size, number, shape and/or arrangement of the depressions and/or elevations.

According to a development, the first element can be designed as a deep-drawn part. In other words, the first element can be produced by a deep-drawing process, in particular using negative pressure (vacuum).

By means of the deep-drawing process, the first element can be produced as simply as possible and thereby be provided with desired contours or structures (depressions and/or elevations) (similarly to a chocolate insert tray). In particular, the thickness of the first element can be varied in a simple manner.

According to a development, the insert part can comprise a second element. The second element can be configured as a support body for the first element and/or for the electrical machine. The second element can in particular be shaping for the first element. The second element can be designed in one piece.

The first element can be designed to be dimensionally unstable (pliable) and the second element can be designed to be dimensionally stable (but flexible; resilient). The second element can be shaping for the insertion part. In particular, the insertion part is designed to be dimensionally stable (but flexible; resilient) due to the second shaped element. This allows the simplest possible installation into the cooling assembly. Moreover, via the second element the electrical machine can be supported radially outwardly relative to the wall of the cooling channel.

Since the second element in particular ensures the dimensional stability of the insertion part, the thickness of the first element can be further reduced. As a result, the first element can be designed to be thinner than a first element that would be dimensionally stable.

According to a development, the second element can be designed as an injection-molded part. In other words, the second element can be produced by an injection-molding process. The second element can be (substantially) flat (planar) in a central section (planar or unstructured surface). The second element can be produced as simply as possible by means of the injection-molding process.

The production of the first element by means of the injection-molding process would be substantially more complex in particular due to the depressions and/or elevations.

According to a development, the first element and/or the second element can be made of plastic. The plastic may be a thermoplastic.

According to a development, the first element and the second element can be connected to one another by means of a clip connection. The first and second elements can be detachably connected to one another.

Alternatively or additionally, the first element and the second element can be connected to one another by means of a welded connection. The first element and the second element can thus be connected to one another non-detachably (integrally bonded).

It is conceivable that the first element and the second element are first connected (pre-fastened) to one another by means of a detachable connection (e.g., clip connection) and are subsequently connected (finally fastened) to one another by means of a non-detachable (integrally bonded) connection (e.g., welded connection).

According to a development, the insert can be collar-like. In an open state, the at least one insertion part of the insert can have a first end and a second end. In a closed state, the two ends can be connected to one another (one insertion part forms the collar-like insert) or to corresponding ends of a further insertion part (one insertion part and a further insertion part (e.g., two insert halves) forming in their entirety the collar-like insert) so that the insert is designed to be hollow-cylindrical.

The two ends of the insertion part or the mutually corresponding ends of the insertion part and the further insertion part can be connected to one another, in particular in the closed state, by means of a welded connection and/or a clip connection. In particular, the insertion part (one insertion part as insert) or the insertion part and the further insertion part (both parts forming the insert) in the state of insertion in the cooling channel are present in the closed state (i.e., hollow-cylindrical).

In the inserted state, the insertion part (one insertion part as insert) or the insertion part and the further insertion part (both parts forming the insert) can in particular at least partially, in particular completely, in particular concentrically (coaxially), surround the receiving region of the electrical machine (or the electrical machine).

According to a development, the insertion part and/or the further insertion part each have at least one clip (a lug) at the first end and at least one groove, corresponding to the clip, at the second end. The clip and the groove can each be arranged at mutually corresponding positions at the two ends.

In the closed state, the clip and the groove can be arranged in a form-fitting engagement with one another. In addition, the clip and the groove can be arranged at least partially in a force-fitting engagement with one another. The insertion part (one insertion part as insert) or the insert and the further insertion part (both parts form the insert) can be held (fastened) in the closed state in particular due to the form-fitting (or partially force-fitting) engagement (clip connection).

The connection of the two ends of the insertion part or of the insertion parts in the closed state (clip connection) can be released again by the form-fitting (or partially force-locking) engagement being released again through application of a force (e.g., by pulling apart the relevant ends).

For (re-) establishing the form-fitting (or partially force-fitting) engagement between the clip and the groove, the clip is pressed into the groove corresponding to the clip, by the application of a force (e.g., by pressing together the two ends of the insertion part or the relevant ends of the insertion parts).

It is likewise conceivable that the two ends of the insertion part or the relevant ends of the insertion parts are additionally or alternatively welded to one another. In other words, the two ends of the insertion part or the relevant ends of the insertion parts can be connected to one another non-detachably (integrally bonded) by means of a welded connection.

According to a development, when the insert is in an inserted state in the cooling channel, the first element is arranged between the second element and the receiving region for the electrical machine (or of the electrical machine). In particular, the second element can surround the first element, possibly concentrically (coaxially).

According to a development, when the insert is in an inserted state in the cooling channel, the second element rests at least partially, in particular completely, against an inner wall of the cooling channel. The inner wall of the cooling channel can delimit the space which surrounds the receiving region for the electrical machine (or of the electrical machine) (radially) outwardly.

In particular, the second element can rest against the inner wall of the cooling channel in such a way that no cooling medium can flow between the second element and the inner wall of the cooling channel. This can prevent a laminar flow from forming between the inner wall of the cooling channel and the (flat) second element (since the second element in particular does not have any elevations and/or depressions or is unstructured).

Moreover, this can ensure that the entire cooling medium flowing through the cooling channel is conducted between the second element and the receiving region for the electrical machine (or of the electrical machine). Since the first element has, in particular, elevations and/or depressions, which cause flow vortices, it can be ensured in this way that the entire cooling medium is converted into the turbulent flow.

Regardless of this, the first element can be designed in such a way that the elevations and/or depressions thereof can be dimensioned in such a way that the first element rests at least in sections, in particular with its elevations, against the housing of the electrical machine. This contributes to a particularly strong turbulent flow.

The aforementioned object is also achieved by an insert for a cooling assembly with one or more of the aspects described above, wherein the insert has at least one insertion part. With regard to the advantages that can be achieved thereby, reference is made to the statements made in this respect about the cooling assembly.

The at least one insertion part can be designed in two parts.

The insertion part can comprise a first element and a second element. The first element has multiple first depressions and/or elevations for generating flow vortices. The first element can be designed as a deep-drawn part. The second element can be configured as a support body for the first element and/or for the electrical machine. The second element can be designed as an injection-molded part.

For the further design of the insert or of the insertion part (s) that form the insert, the measures described above in connection with the cooling assembly can be used.

The aforementioned object is furthermore achieved by a drive assembly, in particular a traction drive, for a vehicle, in particular a motor vehicle, having the features of the further independent claim. The drive assembly comprises an electrical machine and a cooling assembly according to the above statements.

With regard to the advantages that can be achieved thereby, reference is made to the statements made in this respect about the cooling assembly. For the further design of the drive assembly, the measures described in connection with the cooling assembly and/or the measures explained below can be used.

Further features, details and advantages of the invention emerge from the wording of the claims and from the following description of exemplary embodiments with reference to the drawings. In the drawings:

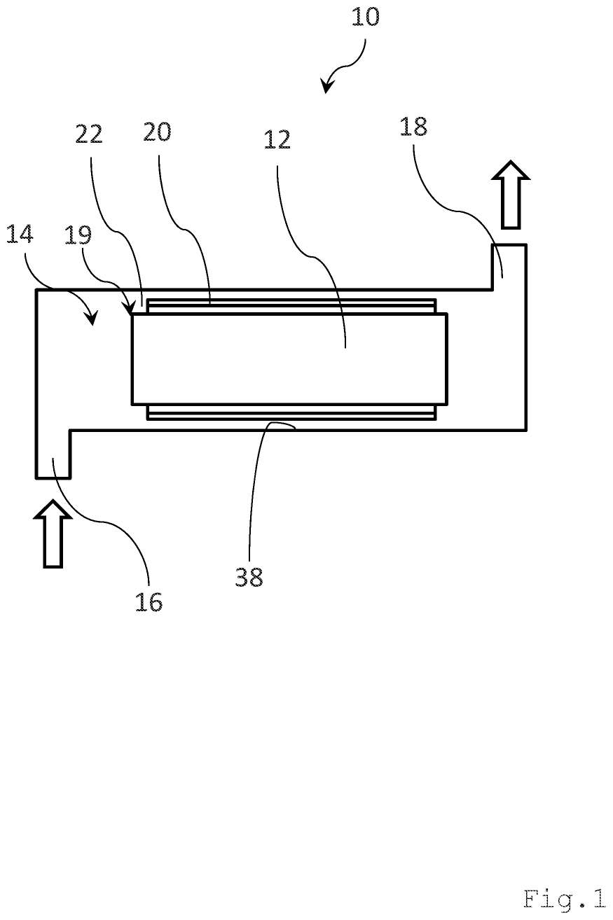

FIG. 1 shows a schematic sectional view of a cooling assembly;

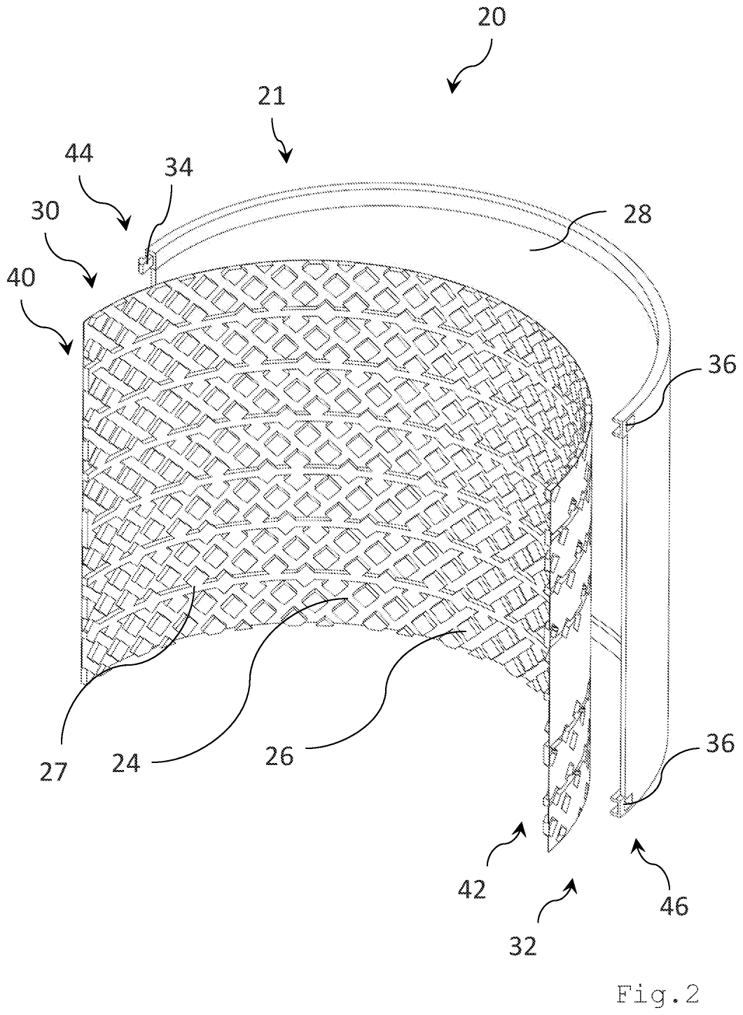

FIG. 2 shows an exploded view of an insert part;

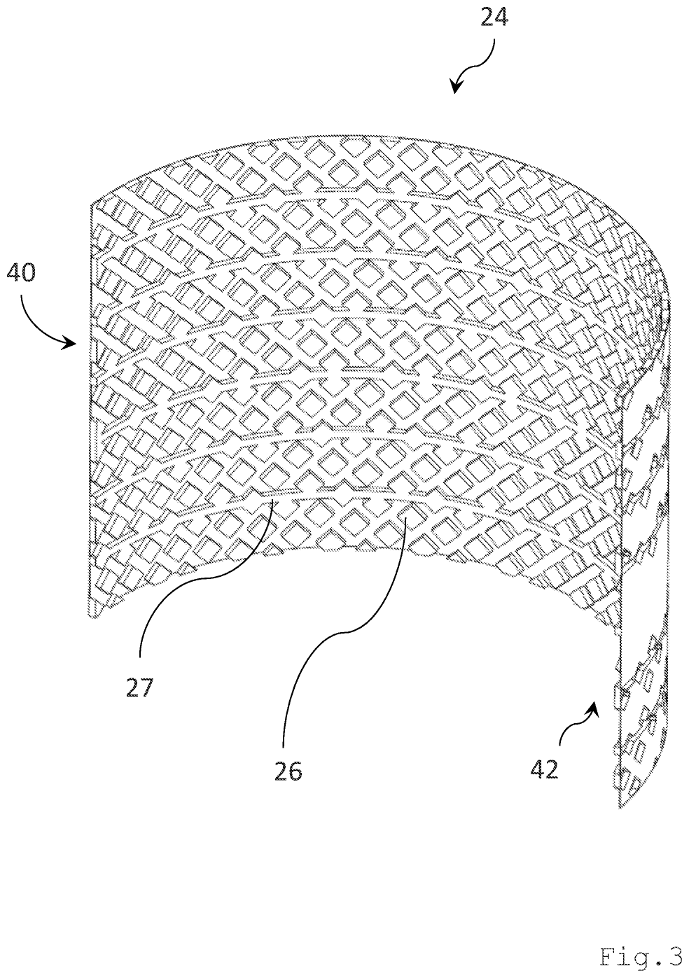

FIG. 3 shows a perspective view of a first element of the insert part according to FIG. 2;

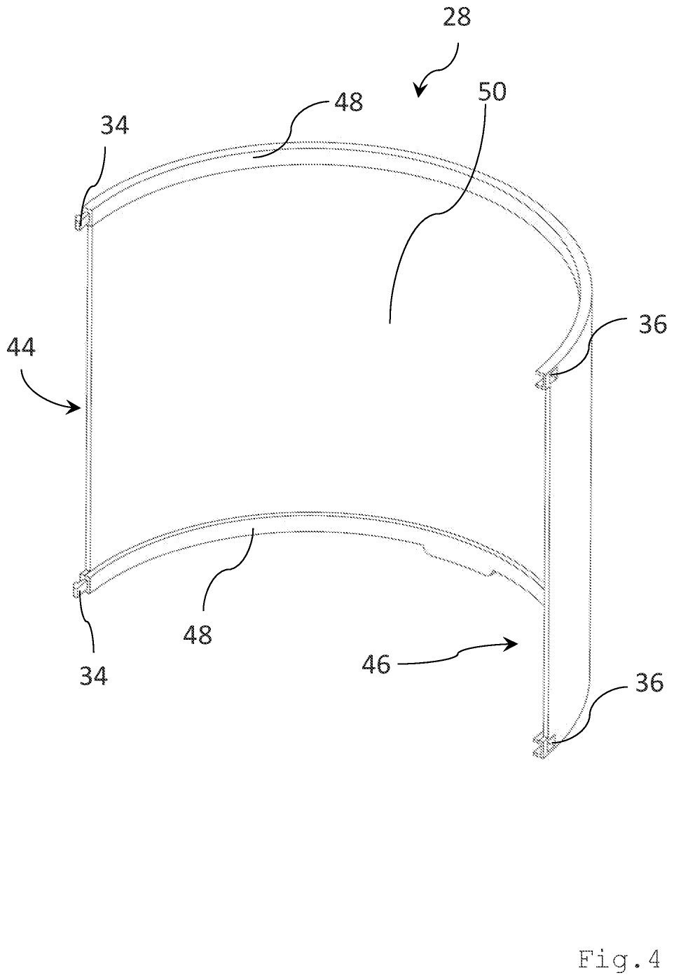

FIG. 4 shows a perspective view of a second element of the insert part according to FIG. 2; and

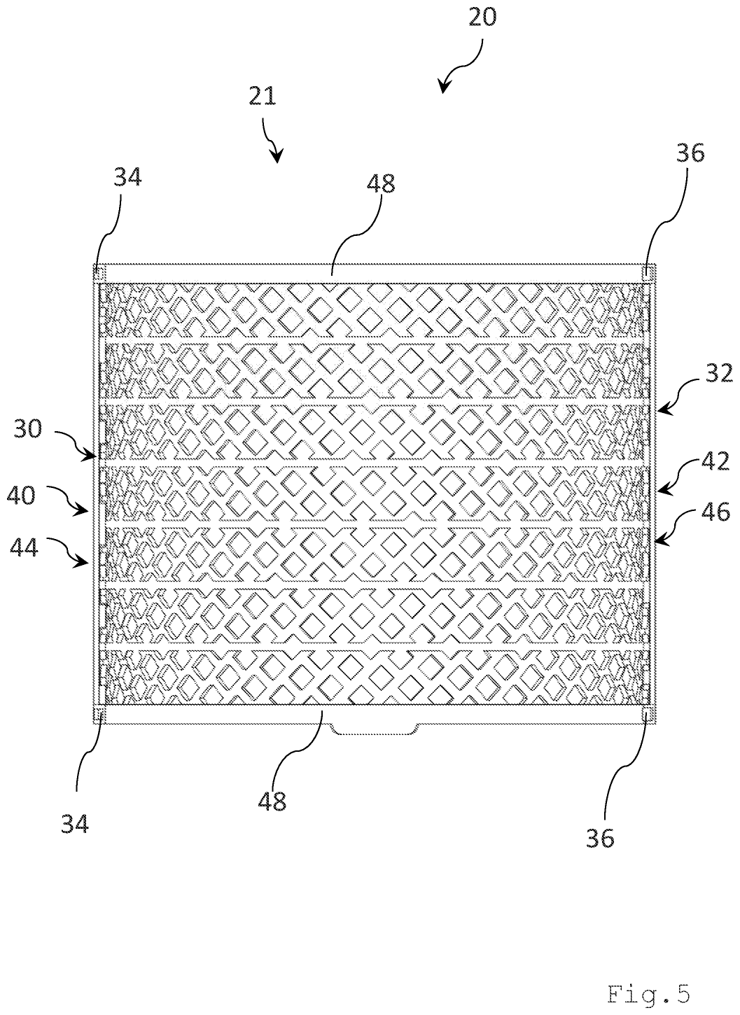

FIG. 5 shows a top view of the insertion part according to FIG. 2.

In the following description and in the figures, corresponding components and elements bear the same reference signs. For improved clarity, not all reference signs are reproduced in all figures.

FIG. 1 shows a schematic sectional view of a cooling assembly 10. The cooling assembly 10 has a cooling channel 14 for conducting a cooling medium. The cooling channel 14 has an inlet 16 for introducing the cooling medium into the cooling channel 14 (indicated by an arrow in FIG. 1). The cooling channel 14 also has an outlet 18 for discharging the cooling medium from the cooling channel 14 (likewise indicated by means of an arrow in FIG. 1).

The cooling medium accordingly passes through the inlet 16 into the cooling channel 14, flows along the cooling channel 14 (on the right in FIG. 1) and is discharged from the cooling channel 14 through the outlet 18.

A receiving region 19 for receiving an electrical machine 12 is arranged within the cooling channel 14. In the present case, the electrical machine 12 is arranged within the receiving region 19 and within the cooling channel 14. A receiving device (not shown) configured to receive the electrical machine 12 can be arranged in the receiving region 19 as explained above.

An insert 20 is arranged within the cooling channel 14. The insert 20 is arranged in the space 22 which surrounds the receiving region 19 or the electrical machine 12 radially outwardly.

In the present case, this space 22 is designed as an annular space between the receiving region 19 or the electrical machine 12 and an inner wall 38 which delimits the cooling channel 14 radially outwardly.

In the present case, the electrical machine 12, the receiving region 19 of the electrical machine, the insert 20, and the inner wall 38 of the cooling channel 14 are arranged coaxially with one another. The components mentioned overlap one another along the axial direction.

FIG. 2 shows an exploded view of the insert 20. The insert 20 has at least one insertion part 21. The insertion part 21 has a first element 24 and a second element 28. FIG. 3 shows a perspective view of the first element 24, and FIG. 4 shows a perspective view of the second element 28. FIG. 5 shows a plan view of the insert 20 according to FIG. 2.

The first element 24 is designed as a deep-drawn part and in the present case has multiple elevations 26, 27. By means of a deep-drawing process, the elevations 26, 27 of the first element 24 can be easily produced in the desired shape, size and arrangement.

The second element 28 is designed as an injection-molded part. The second element 28 has no elevations 26, 27. In other words, apart from reinforcement regions or edge strips 48 (see below), the second element 28 is essentially flat (planar) (unstructured surface). Such a shape can simply be produced by means of the injection-molding process.

The insert 20 is designed like a collar. In FIG. 2, the insertion part 21 is shown in an open state. The insertion part 21 has a first end 30 and a second end 32. Accordingly, the first element 24 has a first end 40 and a second end 42. Likewise, the second element 28 also has a first end 44 and a second end 46.

In a closed state, the two ends 30, 32 of the insertion part 21 can be connected to one another or to corresponding ends of a further insertion part (not shown) (designed analogously to the insertion part 21). Regardless of whether the insert 20 is formed from only one insertion part 21 or from the insertion part 21 and a further insertion part, the insert 20 in the closed state (relevant ends are connected to one another) assumes a hollow-cylindrical shape (not shown).

In a state of the insert 20 mounted (inserted) in the cooling assembly 10, the insertion part (s) 21 are present in the closed state. The insertion part (s) 21 are already transferred into the closed state for assembly or insertion into the cooling assembly 10.

For this purpose, the second element 28 in each case has two clips 34 at the first end 44. At the second end 46, the second element 28 in each case has two grooves 36 corresponding to the respective clips 34. The clips 34 and the grooves 36 form a releasable clip connection (see FIG. 4).

The clips 34 and the grooves 36 can be brought into form-fitting engagement with one another by the application of a force (e.g., by pressing together the two ends 44, 46 of the second element 28). The clips 34 and the grooves 36 remain in engagement and hold the second element 28 and accordingly the insertion part 20 in the closed state.

In order to release this clip connection, the two ends 44, 46 of the second element 28 are moved away from one another by the application of a force (e.g., by pulling apart the two ends 44, 46) until the form-fitting engagement between the clips 34 and the grooves 36 is released again.

In the closed state and in the state when inserted in the cooling assembly 10, the second element 28 surrounds the first element 24 radially outwardly.

In the present case, the first element 24 has multiple elevations 26 formed in the example (substantially) square, which are arranged in a regular pattern. In addition, the first element 24 has multiple linear elevations 27 arranged at regular (identical) distances from one another (see FIG. 3).

When the cooling medium is guided past the first element 24, the elevations 26, 27 generate flow vortices in the cooling medium which generates a turbulent flow.

In the present case, the second element 28 has two reinforcement regions 48 or edge strips which each extend from a clip 34 to the respectively corresponding groove 36 along the edge of the second element 28. The reinforcement regions 48 have a greater thickness than the remaining planar body 50 of the second element 28 (see FIG. 4).

The stability of the second element 28 and accordingly the stability of the insertion part 20 can be increased by the reinforcement regions 48 thicker than the planar body 50 (unstructured surface).

Moreover, the reinforcement regions 48 serve as a securing device for the first element 24. The first element 24 is delimited by the reinforcement regions 48 of the second element 28 in an assembled state of the insertion part (s) 21 and accordingly fastened in the axial direction (see FIG. 5).

1. A cooling assembly for cooling an electrical machine of a drive assembly comprising the electrical machine, the cooling assembly comprising:
a cooling channel for conducting a cooling medium with an inlet for introducing the cooling medium into the cooling channel and with an outlet for discharging the cooling medium from the cooling channel, wherein
the cooling channel has a receiving region for receiving the electrical machine,
the cooling assembly comprises an insert with at least one insertion part for generating turbulence of the cooling medium within the cooling channel,
wherein the insert is arranged in a space surrounding the receiving region for the electrical machine, within the cooling channel, and
wherein the insertion part has a two-part design.

2. The cooling assembly according to claim 1,
wherein the insertion part comprises a first element, and
wherein the first element has multiple depressions and/or elevations for generating flow vortices.

3. The cooling assembly according to claim 2,
wherein the first element is designed as a deep-drawn part.

4. The cooling assembly according claim 2,
wherein the insertion part comprises a second element and,
wherein the second element is configured as a support body for the first element and/or for the electrical machine.

5. The cooling assembly according to claim 4, wherein
the second element is configured as an injection-molded part.

6. The cooling assembly according to claim 4,
wherein the first element and/or the second element is made of plastic.

7. The cooling assembly according to claim 4,
wherein the first element and the second element are connected to one another by means of a welded connection and/or by means of a clip connection.

8. The cooling assembly according to claim 1,
wherein the insert is designed like a collar,
wherein the insertion part has a first end and a second end in an open state, and
wherein both ends are connected to one another or to corresponding ends of another insertion part in a closed state so that the insert is hollow-cylindrical.

9. The cooling assembly according to claim 8,
wherein the insertion part and/or the additional insertion part each have at least one clip at the first end and at least one groove corresponding to the clip at the second end.

10. The cooling assembly according to claim 4,
wherein when the insert is in an inserted state in the cooling channel, the first element is arranged between the second element and the receiving region for the electric machine.

11. The cooling assembly according to claim 10,
wherein the second element, when in an inserted state in the cooling channel, rests at least partially, against an inner wall of the cooling channel delimiting the space which surrounds the receiving region for the electrical machine towards the outside.

12. The insert having at least one said insertion part for said cooling assembly according to claim 1.

13. The drive assembly, for said vehicle, comprising the electrical machine and the cooling assembly according to claim 1.

14. The cooling assembly according to claim 10,
wherein the second element, when in an inserted state in the cooling channel, rests completely, against an inner wall of the cooling channel delimiting the space which surrounds the receiving region for the electrical machine towards the outside.
